(19) United States
(12) Patent Application Publication
(10) Pub. No.: US 2008/0014437 A1
(43) Pub. Date: Jan. 17, 2008

(54) COMPONENT AND ASSOCIATED CONNECTION WIRE

(75) Inventor: Jochen Dangelmaier, Beratzhausen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Muenchen (DE)

(21) Appl. No.: 11/776,184

(22) Filed: Jul. 11, 2007

(30) Foreign Application Priority Data
Jul. 11, 2006 (DE) 10 2006 032 074.3

(51) Int. Cl. B32B 15/04

(52) U.S. Cl. 428/332; 428/472.3

(57) ABSTRACT

A component and associated connection wire is disclosed. One embodiment includes a first connection region for connecting a first workpiece and a second connection region for connecting a second workpiece. In one embodiment a NiP layer is formed on a Ni layer at least in the second connection region.

### CROSS-REFERENCE TO RELATED APPLICATIONS

This Utility Patent Application claims priority to German Patent Application No. DE 10 2006 032 074.3 filed on Jul. 11, 2006, which is incorporated herein by reference.

### BACKGROUND

The present invention relates to a component and an associated connection wire and, in one embodiment, to a connection wire coating with an Ni/NiP double layer.

Connection wires or leadframes are usually used for making contact with components and, in particular, semiconductor devices or chips on, for example, a printed circuit or circuit board.

In this case, in a first region of the connection wires, the semiconductor device is contact-connected to the connection wire by using bonding wires, for example, and the semiconductor device together with at least one partial section of the connection wire is subsequently housed or encapsulated in a plastic housing. The connection wires or pins projecting from the housing then serve for a respective contact-connection on a printed circuit board, for example.

Tin (Sn) is usually used as “final plating” or final coating for connection wires of this type. What is disadvantageous in this case, however, is the high risk of “whisker growth”, in the case of which short circuits and the like can occur on account of filament formation of the tin, in particular. In particular, such “whisker growth” constitutes a long-term phenomenon which is difficult to control and which adversely influences the reliability of an electronic circuit.

Therefore, in order to avoid such whisker growth and in order to improve a reliability of integrated semiconductor circuits, in particular, different coatings are used as preplating and as postplating in the case of connection wires. In this case, preplating is understood to mean the formation of a coating on the connection wire prior to the formation of the housing or prior to the encapsulation, while postplating is understood to mean the formation of a coating on the connection wire after the formation of the housing or after the encapsulation.

As conventional coatings of this type, for example Ni/Pd/Au triple layers have hitherto been used as preplating and postplating. Furthermore, Ni/Pd double layers are also known for use as interlayer in a coating.

However, in specific areas of application such as the automotive area, for example, such integrated circuits and, in particular, the connection wires thereof are exposed to extreme ambient influences. What is more, they must be suitable for special contact methods such as, for example, laser welding, laser soldering and/or resistance welding in order to ensure a reliable electrical and mechanical connection.

For these and other reasons, there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates a simplified sectional view of a component with connection wires.

FIG. 2 illustrates an enlarged partial sectional view of a connection wire in accordance with a first exemplary embodiment.

FIG. 3 illustrates an enlarged partial sectional view of a connection wire in accordance with a second exemplary embodiment.

FIG. 4 illustrates an enlarged partial sectional view of a connection wire in accordance with a third exemplary embodiment.

FIG. 5 illustrates an enlarged partial sectional view of a connection wire in accordance with a fourth exemplary embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

One or more embodiments provide a connection wire including a first connection region for connecting a first workpiece and a second connection region for connecting a second workpiece, wherein an NiP layer is formed on an Ni layer at least in the second connection region.

Furthermore, one or more embodiments provide a component including a first workpiece, including at least one connection wire for connecting the first workpiece to a second workpiece, and including a housing for enclosing at least the first workpiece, wherein the connection wire has an Ni layer and an NiP layer formed on the Ni layer.

In accordance with one or more embodiments, an Ni/NiP coating is formed at least in the device-remote connection region of the connection wire. As a result, with whisker growth being avoided a hundred percent, it is possible for the first time to provide a connection wire which is extremely resistant to ambient influences and which is also suitable for laser welding, laser soldering and/or resistance welding. Furthermore, moist pretreatments that are usually carried out such as e.g., during soldering tests (dip and look) are passed without any problems.

The connection wire may be composed of Cu or a Cu alloy, for example, whereby outstanding electrical properties and, in particular, very high conductances are obtained.

Furthermore, an Au layer may be formed as a topmost protective layer, whereby in particular organic contaminants in underlying layers can be reliably prevented.

Furthermore, there may be formed as protective layer a Pd layer and thereon an Au layer, whereby in particular bonding properties are improved further and oxidation protection for the Ni/NiP double layer is furthermore produced. Furthermore, the Pd layer acts as a diffusion barrier for avoiding an undesirable outdiffusion of Cu material.

There may also be formed on the Ni/NiP double layer an Ag layer and thereon an Au layer, whereby connection wires suitable for laser soldering, in particular, are obtained.

Although the connection wire may have the same coating in the first connection region and in the second connection region, according to the invention it is also possible to use, in particular in the first connection region, which is used for connecting the semiconductor device, in particular, a different coating such as, for example, a Pd/Au double layer, an Ni/Cr/Au triple layer, an Ni/Pt/Au triple layer and an Ni/Ti/Au triple layer. In the case of such a mixed coating of the connection wire on its distal ends, the production costs can be reduced and outstanding contact properties that withstand even the most extreme ambient influences can furthermore be realized.

The Ni layer may have a layer thickness of 0.1 to 3.5 micrometers and the NiP layer may have a layer thickness of 10 to 500 nanometers, wherein the Ni layer may furthermore have a hardness of 120 to 250 HV (Vickers hardness). With such specific layer thickness and material properties, the layers can be reliably prevented from tearing in the course of shaping or in the course of bending (trim and form), thereby obtaining outstanding wear and corrosion protection in particular for moist pretreatments.

Some exemplary embodiments are presented below with reference to figures that serve merely for illustration and do not restrict the scope of the invention.

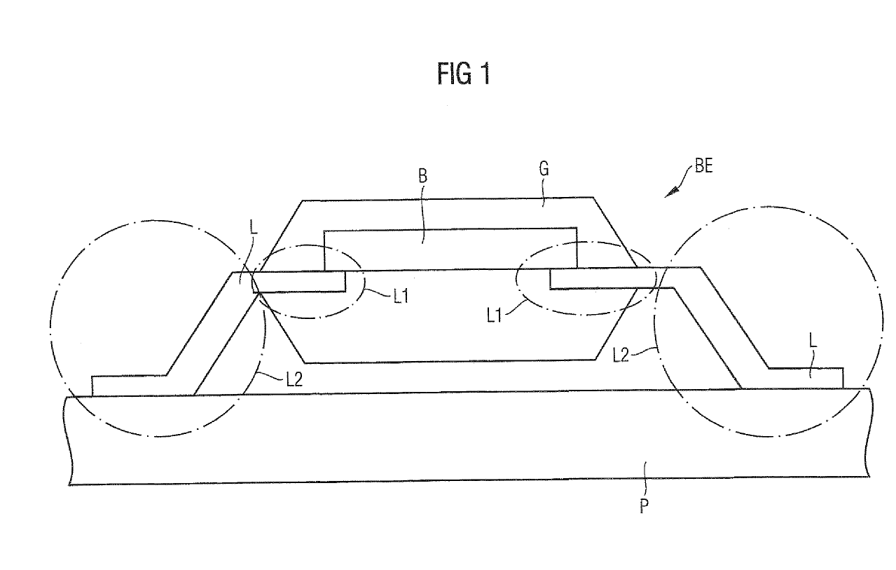

FIG. 1 illustrates a simplified sectional view for illustrating a component according to the invention with connection wires according to the invention.

In accordance with FIG. 1, the component BE has a semiconductor device or semiconductor chip B with an integrated circuit, a leadframe having a multiplicity of connection wires L and a housing G, which completely encloses the semiconductor device B. The housing G may constitute a plastic housing, for example, which is produced by using casting methods. In principle, other housings such as e.g., ceramic housings are also conceivable. Furthermore, it is also possible to accommodate a plurality of semiconductor devices B in a housing.

In accordance with FIG. 1, each connection wire L has a first connection region L1 in the vicinity of the semiconductor device B or die to be contact-connected and a second connection region L2, which is usually situated outside the housing G for the semiconductor device B. The first connection region L1 may constitute e.g., a bonding region which can be electrically connected via bonding wires (not illustrated) to corresponding connection pads on the semiconductor device B. Accordingly, the first connection region L1 can be situated completely within the housing G.

The second connection region L2 constitutes a soldering or welding region, for example, which can be soldered or welded e.g., onto corresponding contact areas of a printed circuit or circuit board P by using e.g., solder balls. By way of example, the first and second connection wire regions L1 and L2 may be situated at the distal, i.e. most remote, ends of the connection wire L.

In accordance with FIG. 1, the connection wires L have already been brought to their final form by a shaping process (trim and form), FIG. 1 illustrating a form for SMD mounting (Surface Mounted Device). It goes without saying that it is also possible to select or produce any other shapings for any other connection techniques for the connection wire L. In the case of the SMD technique, these are for example BGA (Ball Grid Array), PGA (Pin Grid Array) or LGA (Land Grid Array). It goes without saying that in addition to the SMD components described, it is also possible to use conventional wired components such as e.g., SIP (Single In-Line Package), DIP (Dual In-Line Package) or ZIP (Zigzag In-Line Package).

In contrast to the first connection region L1, which is designed e.g., for a contact-connection at the semiconductor device B by using bonding wires, the second connection region L2 of the connection wire L constitutes a soldering and/or welding region, in which case a contact to the circuit board or printed circuit board P can be produced by soldering and/or welding, for example. In the present example, in particular the foot or the sole thereof of the connection wire L serves for such contact-connection by using soldering and/or welding.

In order to avoid the whisker growth described in the introduction, in the case of which filament formations often lead to short circuits or to an impairment of the contacts particularly when tin is used as topmost layer of the connection wire L, a leadframe or connection wire L having a specific coating is used according to the invention.

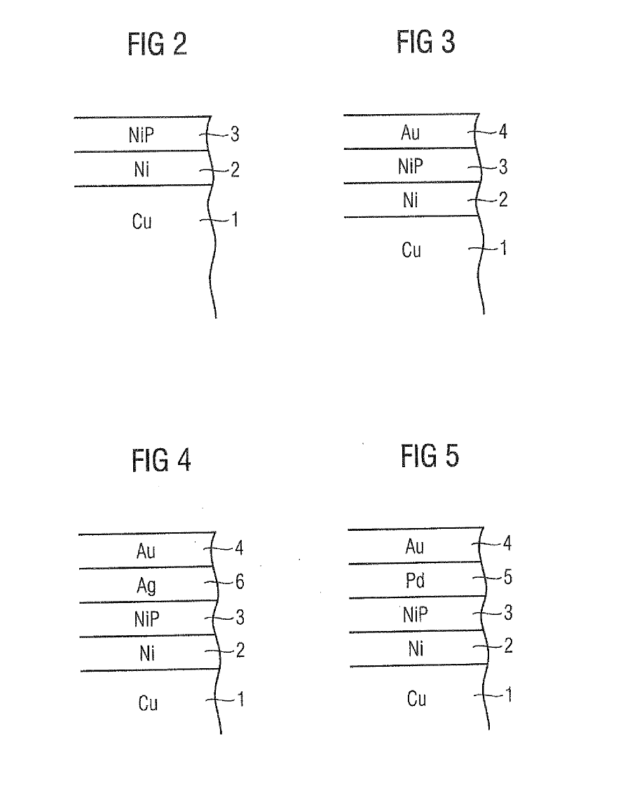

FIG. 2 illustrates an enlarged partial sectional view of a connection wire surface, the connection wire L having a Cu substrate layer 1 as core layer. As an alternative to such a substrate layer 1 composed entirely of copper, it is also possible to use Cu alloys as substrate layer 1. In particular, Cu alloys having a predetermined proportion of Cr, Si, Ti, Fe and/or P can be used in this case. As an alternative to such layers including Cu, an NiFe layer can also be used as substrate layer 1. However, the best electrical properties are obtained with substrate layers including Cu.

In accordance with FIG. 1, the layer sequence illustrated in FIG. 2 is situated at least in the second connection region L2 and in this case at least in the later actual contact region of the connection wire region L2 such as, for example, the lower surface of the foot of the connection wire L. It goes without saying that this coating can also be formed on the entire second connection region L2 of the connection wire L, the region projecting from the housing.

In accordance with FIG. 2, a Ni layer 2 can now be situated on the surface of the substrate layer or the core 1 of the connection wire L, an NiP layer 3 furthermore being situated directly on the surface of the Ni layer 2. This results in a Ni/NiP double layer which, as soldering surface or as “final plating”, reliably prevents whisker growth that is usually to be observed. The Ni layer 2 may have e.g., a layer thickness of 0.1 micrometer to 3.5 micrometers and a hardness of 120 to 250 HV (Vickers hardness). The NiP layer 3 formed directly on the Ni layer 2 has, for its part, a layer thickness of 10 nanometers to 500 nanometers, the P content being set to 10 to 13 percent by weight.

The layers 2 and 3 can be formed galvanically, for example, on the substrate layer 1. On account of the relatively low hardness of the Ni layer 2 and the layer thicknesses chosen, a ductile, i.e. flexible, middle layer is obtained which, during the shaping of the connection wires, reliably prevents the layers from tearing and furthermore acts as a diffusion barrier to copper, in particular.

Particularly when carrying out laser welding or resistance welding for contact-connecting the connection wires L on a printed circuit or circuit board P, on account of the low reflection of the Ni layer 2, a laser beam used e.g., during welding can couple in well and the connection wire L can be welded well to the partner material.

The NiP layer 3 serves in particular as wear protection and corrosion protection, whereby the moist pretreatments usually required during soldering tests (dip and look) can be reliably passed. The NiP layer 3 may have a hardness of 500 HV (Vickers hardness), for example. Such a pretreatment includes for example a dry thermal treatment for approximately 16 hours at 155° C., followed by a moist storage at 85° C. and 85% relative humidity for 48 hours. Finally, “steam ageing” or artificial ageing of a connection wire in a steam bath is carried out for approximately one to eight hours. Such a moist pretreatment is passed without any problems by the Ni/NiP double layer according to the invention, whereby extremely reliable and readily processable connection wires L are obtained which yield outstanding results even in particular under extreme ambient conditions such as, for example, during use in the automotive area.

According to one embodiment, the Ni/NiP double layer described above can be formed prior to the formation of the housing G (preplating) or after the formation of the housing G (postplating).

Although the Ni/NiP double layer described above can be formed for example only on the second connection region L2, i.e. in the outer region and in particular on a contact region of the connection wire L, this same coating can also be situated on the entire connection wire L and thus also in the inner connection region L1 or a bonding region.

FIG. 3 illustrates an enlarged partial sectional view of a connection surface of the connection wire L in accordance with a second exemplary embodiment, identical reference symbols designating layers identical to those in FIG. 2, for which reason a repeated description is dispensed with below.

In accordance with FIG. 3, an Au layer 4 may furthermore be formed on the Ni/NiP double layer 2 and 3 formed directly on the substrate layer 1 including Cu, whereby in particular a contact-connection by using laser soldering is improved. In this case, the Au layer 4 serves for improved starting of the soldering process. By way of example, the Au layer 4 may have a layer thickness of between 5 and 100 nanometers. Furthermore, the Au layer 4 also serves as a protective layer for avoiding contaminants and, alongside the soldering surface, is also highly suitable as bonding surface in the first connection region L1.

FIG. 4 illustrates an enlarged partial sectional view of a connection surface of the connection wire in accordance with a third exemplary embodiment, identical reference symbols designating layers identical to those in FIGS. 2 and 3, for which reason a repeated description is dispensed with.

In accordance with FIG. 4, as topmost layers, an Ag layer 6 with succeeding Au layer 4 thereon may also be formed on the Ni/NiP double layer 2, 3, whereby in particular interdiffusion via temperature can be avoided. In this case, the Ag layer 6 may have a layer thickness of between 0.5 micrometer and 6 micrometers, while the Au layer 4 in this case may have for example a layer thickness of 5 nanometers to 0.5 micrometer. Such a coating can be used as soldering surface once again in particular for laser soldering and can be applied e.g., in a postplating process after the formation of the housing G in the outer region of the connection wire L. The method for producing the layers is once again an electroplating method, by way of example.

As an alternative to the Au layer 4, hard gold layers such as Au—Co or Au—Ni, for example, can also be used in this exemplary embodiment. These coatings are suitable in particular for use in “through hole packages”, in which the connection wire L is led through an opening in the printed circuit board P.

FIG. 5 illustrates an enlarged partial sectional view of a connection surface of a connection wire in accordance with a fourth exemplary embodiment, identical reference symbols designating layers identical to those in FIGS. 2 to 4, for which reason a repeated description is dispensed with below.

In accordance with FIG. 5, a Pd layer 5 and thereon an Au layer 4 may be applied directly on the layer stack including the substrate layer 1 and the Ni/NiP double layer 2 and 3. Such a layer construction Ni/NiP/Pd/Au can be used as identical coating both for the first or inner connection region L1 and for the outer or second connection region L2 of the connection wire L since it has both outstanding soldering and welding properties and excellent bonding properties.

In accordance with this embodiment, a ductile nickel layer 2 having a low hardness of e.g., 180 to 250 HV (Vickers hardness) can be applied (e.g., galvanically) on the substrate layer 1 composed of pure Cu or a Cu alloy, whereby the layers are reliably prevented from tearing in the course of bending and shaping (trim and form). The layer thickness of the Ni layer 2 is 0.1 to 2 micrometers, for example, in order to limit a total thickness.

An NiP layer 3 is once again applied (e.g., galvanically) as wear and corrosion protection on the Ni layer 2, a P content of between 10 and 13% by weight being set. The NiP layer 3 may have a layer thickness of 10 to 200 nanometers and thus makes it possible to pass without any problems the moisture pretreatments described in the introduction for soldering tasks (dip and look). Alongside the extremely resistant properties toward ambient influences, this Ni/NiP double layer once again has outstanding properties for laser welding, resistance welding or laser soldering, since, by virtue of the low reflection particularly at the Ni layer 2, a respective laser beam can couple in well and, consequently, the connection wire L can be welded or soldered well to the circuit board P.

In accordance with FIG. 5, a Pd layer 5 as bonding and soldering surface is furthermore applied galvanically, for example, on the surface of the NiP layer 3, the Pd layer furthermore constituting oxidation protection for the layers including Ni. The Pd layer 5 has e.g., layer thicknesses of between 5 and 150 nanometers.

Finally, an Au layer 4 is applied as protective layer for the Pd layer 5, which is susceptible in particular to organic contaminants. The Au layer 4 likewise serves as bonding and soldering surface, whereby the coating in accordance with FIG. 5 can be used both in the outer region and in the inner region of the connection wire as both bonding surface and soldering or welding surface.

In addition to the use of an identical coating in the first connection region L1 and in the second connection region L2, and in particular at the contact regions thereof, in order to reduce the production costs it is also possible according to the invention to use different coatings on the connection wire L.

In particular this applies to the first or inner connection region L1, which is intended to constitute a suitable bonding surface for “die bonding”, for example. While the outer or second connection region L2 accordingly has the layer sequences described above and in particular the Ni/NiP double layer as coating, the first or inner connection region L1 can also be equipped with different coatings and be combined with the coatings described above.

To put it more precisely, alongside the above-described Ni/NiP/Pd/Au coating in the first connection region L1 or the contact region thereof, it is also possible for only a Pd/Au double layer to be formed directly on the substrate layer 1.

As an alternative, a Ni/Cr/Au triple layer can be formed directly on the substrate layer 1 in the first connection region L1 or the contact region thereof.

Furthermore, a Ni/Pt/Au triple layer or a Ni/Ti/Au triple layer can be formed directly on the substrate layer 1, which is composed of Cu, for example, in the first connection region L1 or the contact region thereof.

In particular for AuSn and AuSi chip rear sides and other chip rear sides having a higher melting point, which require a higher die bonding temperature, these layer structures enable stable connections to the chip rear sides of the semiconductor device B and do not tend toward voiding even upon very long storage (>2000 hours).

The layer thicknesses of the Ni layer used in these layer structures may be between 0.1 and 2 micrometers, while the layer thicknesses of the Cr, Pt and Ti layers used in this layer structure may be 5 to 150 nanometers. The layer thicknesses of the Au layer formed in this layer structure may be 5 to 100 nanometers, for example.

A connection wire having greatly improved bonding, soldering and welding properties is obtained in this way, a durability being greatly improved. In particular, whisker growth can be virtually completely avoided and the production costs can be noticeably reduced.

Embodiments of the invention have been described above on the basis of a connection wire for an SMD component. However, it is not restricted thereto and also encompasses in the same way connection wires and connection wire coatings for any desired components. In particular, the invention has been described on the basis of an active component with a semiconductor device. However, it is not restricted thereto and also encompasses in the same way passive components such as e.g., coils, capacitors or resistors.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A component having a connection wire comprising:
a first connection region for connecting a first workpiece; and
a second connection region for connecting a second workpiece, wherein a NiP layer is formed on a Ni layer at least in the second connection region.

2. The component of claim 1, comprising wherein the Ni layer is formed on a substrate layer comprising Cu.

3. A component of claim 1, comprising wherein an Au layer is formed on the NiP layer.

4. A component of claim 1, comprising wherein there is formed on the NiP layer a Pd layer and thereon an Au layer.

5. A component of claim 1, comprising wherein there is formed on the NiP layer an Ag layer and thereon an Au layer.

6. A component of claim 4, comprising wherein the first connection region has the same coating as the second connection region.

7. The component of claim 1, comprising wherein the first connection region has a Pd/Au double layer.

8. The component of claim 1, comprising wherein the first connection region has a Ni/Cr/Au triple layer.

9. The component of claim 1, comprising wherein the first connection region has a Ni/Pt/Au triple layer.

10. The component of claim 1, comprising wherein the first connection region has a Ni/Ti/Au triple layer.

11. The component of claim 1, comprising wherein the Ni layer has a layer thickness of 0.1 micrometer to 3.5 micrometers.

12. The component of claim 1, comprising wherein the NiP layer has a layer thickness of 10 nanometers to 500 nanometers.

13. The component of claim 1, comprising wherein the Ni layer has a hardness of 120 to 250 HV.

14. The component of claim 1, comprising wherein the NiP layer has a P content of 10 to 13 percent by weight.

15. The component of claim 1, comprising wherein the workpiece constitutes a semiconductor device.

16. The component of claim 1, comprising wherein the first connection region has a bonding region.

17. The component of claim 1, comprising wherein the second connection region has a soldering and/or welding region.

18. A connection wire comprising:
a bonding region for connecting a semiconductor device and a soldering and/or welding region for connecting a printed circuit board, wherein at least the soldering and/or welding region has a Ni/NiP coating.

19. A connection wire comprising:
a bonding region for connecting a semiconductor device and a soldering and/or welding region for connecting a printed circuit board, wherein at least the bonding region has a Ni/NiP/Pd/Au coating.

20. A component having a connection wire comprising:
a first workpiece;
at least one connection wire for connecting the first workpiece to a second workpiece; and
a housing for enclosing at least the first workpiece, wherein the connection wire has an Ni layer and a NiP layer formed on the Ni layer.

21. The component of claim 20, comprising wherein the first workpiece comprises a semiconductor device.

22. The component of claim 20, comprising wherein the first workpiece is connected to the connection wire via a bonding wire.

23. The component of claim 20, wherein the second workpiece is connected to the connection wire, via a solder ball.

24. A component having a connector comprising:
a semiconductor device;
a first connection region for connecting the semiconductor device; and
a second connection region for connecting a second workpiece, wherein a NiP layer is formed on a Ni layer at least in the second connection region.

25. The component of claim 24, where the second workpiece comprises a circuit board.

26. A component of claim 24, comprising wherein an Au layer is formed on the NiP layer.

27. A component of claim 24, comprising wherein there is formed on the NiP layer a Pd layer and thereon an Au layer.

28. A component of claim 24, comprising wherein there is formed on the NiP layer an Ag layer and thereon an Au layer.

29. The component of claim 24, comprising wherein the first connection region has a Pd/Au double layer.

30. The component of claim 24, comprising wherein the first connection region has a Ni/Cr/Au triple layer.
